(19) United States
(12) Patent Application Publication
(10) Pub. No.: US 2008/0198613 A1
(43) Pub. Date: Aug. 21, 2008

(54) LED driver touch switch circuit

(76) Inventor: William Cruickshank, Rochester Hills, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/706,721

(22) Filed: Feb. 15, 2007

(51) Int. Cl. B60Q 1/24

(52) U.S. Cl. 362/488; 362/487

(57) ABSTRACT

A vehicular touch switch activated LED illumination circuit includes a LED illumination source for providing vehicle illumination. A touch switch antenna senses a user input for activating and deactivating the LED illumination source. An integrated circuit mounted to a printed circuit board for controlling the current provided to the LED illumination source. The integrated circuit is in communication with the touch switch antenna for detecting the user input. A driver circuit is mounted to the printed circuit board and is electrically coupled to the LED illumination source for driving the LED illumination source. The integrated circuit includes a battery voltage sensed input and a temperature sensed input for receiving sensed input signals to control a signal input to the driver circuit for variably controlling the current provided to the illumination source.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

1. Field of Invention

This invention relates in general to vehicle illumination, and more specifically, to LED vehicle illumination.

2. Background of Related Art

Incandescent lighting systems have been extensively used for vehicle interior and exterior lighting systems. Incandescent lamps provide a simple and inexpensive electrical lighting system by only requiring a voltage supply to energize a resistive element within the incandescent light, known as a filament, for vehicle illumination. Current is applied to the filament within a glass casing of the bulb causing it to heat up and emit light. However, standard incandescent light bulbs are typically not energy efficient and have a much shorter life than other lighting systems. Incandescent light bulbs have high thermal losses, and as a result, temperature concerns must be taken into consideration when packaging the incandescent lights in specific regions of the vehicle. As a result of the heat dissipation, the effect of the heat on various surrounding components result in the use of costly materials having superior thermal properties for shielding the dissipated heat from various surrounding components which may otherwise cause adverse affects.

A recent trend has been to replace incandescent light bulbs with other light elements such as light emitting diodes (LEDs). LEDs are known in the art to have a small package size, minimal heat loss,.lower power requirements, longer service life, and are more resistant to thermal shock that incandescent light bulbs. LEDs emit a narrow spectrum of light when electrically biased in a forward direction. LEDs can operate by a direct current voltage supply or an alternating current voltage supply, but they will only illuminate when a positive voltage is applied. As a result, the use of alternating current voltage will cause the LED to turn on and off at the frequency of the AC supply.

Small voltage changes in the supply to a LED may result in a large change in current. Therefore, the supply voltage must be precisely controlled so that high currents are not supplied to the LED which may otherwise cause permanent damage to the LED. The power to drive the LED can be considered to be primarily proportional to the current, and therefore, a current-type driving device is recommended. In addition, most LEDs have low reverse breakdown voltage ratings, so they will also be damaged by an applied reverse voltage of more than a few volts. As a result, a more complex power supply system must be used to drive the LED than that of the incandescent light bulb. Moreover, to increase efficiency to control the intensity of illumination, either a digital-to-analog converter may be used or the power must be applied periodically or intermittently.

LED performance depends largely on the ambient temperature of the operating environment to which the LED is exposed. High illumination of the LED in high ambient temperatures may result in overheating of the LED and may eventually lead to permanent damage of the LED. Therefore, to adequately drive the LED to the desired operating conditions, complex circuitry is required. Such complex circuitry typically includes numerous printed circuit boards having circuitry to monitor and control various operating conditions such as temperature conditions, the vehicle voltage supply system, the operating current feedback, and user command inputs. As a result, the complexity of packaging and communicating between the PCB's adds cost and requires package space which may potentially make the LED not a feasible replacement for incandescent lighting.

### BRIEF SUMMARY OF THE INVENTION

The present invention has the advantage of reducing a number of electrical circuits required for illuminating a LED illumination source by utilizing a single integrated circuit to receive sensed inputs and pulse width drive an LED driver circuit. The integrated circuit also reduces a number of analog comparator circuits by utilizing A/D inputs on the integrated circuit. A touch switch and LED illumination source may further be packaged as a module with the electronic circuitry.

In a preferred embodiment of the present invention, a vehicular touch switch activated LED illumination circuit includes a LED illumination source for providing vehicle illumination. A touch switch antenna senses a user input for activating and deactivating the LED illumination source. An integrated circuit mounted to a printed circuit board for controlling the current provided to the LED illumination source. The integrated circuit is in communication with the touch switch antenna for detecting the user input. A driver circuit is mounted to the printed circuit board and is electrically coupled to the LED illumination source for driving the LED illumination source. The integrated circuit includes a battery voltage sensed input and a temperature sensed input for receiving sensed input signals to control a signal input to the driver circuit for variably controlling the current provided to the illumination source.

In yet another preferred embodiment of the present invention, a vehicular touch switch activated LED illumination module includes a first printed circuit board and a second printed circuit board. A LED illumination source is mounted to the first printed circuit board for providing vehicle illumination. A touch switch antenna is mounted to the first printed circuit board in spaced relation to the LED illumination source. The touch switch antenna senses a user input for activating and deactivating the LED illumination source. An integrated circuit is mounted to the second printed circuit board for controlling the current provided to the LED illumination source. The integrated circuit is in communication with the touch switch antenna for detecting the user input. A driver circuit is mounted to the second printed circuit board is electrically coupled to the LED illumination source mounted on the first printed circuit board for driving the LED illumination source. The integrated circuit includes a battery voltage sensed input and a temperature sensed input for receiving sensed inputs to control the signal input to the driver circuit for variably controlling the current provided to the illumination source. The first printed circuit board and the second printed circuit board are mounted in a module.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a circuit diagram for the illumination circuit according to a first preferred embodiment of the present invention.

FIG. 2 is a view of a vehicle interior and exterior according to the present invention.

FIG. 3 is a perspective view perspective view of a circuit diagram for the illumination circuit according to a first preferred embodiment of the present invention.

### DETAILED DESCRIPTION OF THE PREFERRED EMBODIMENT

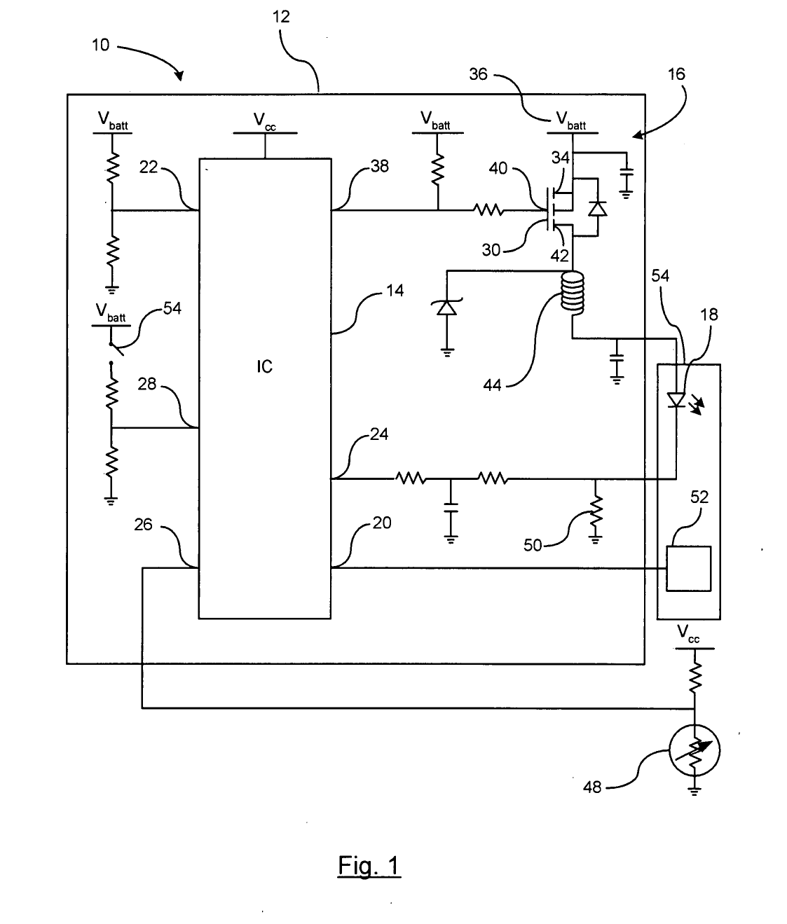

There is shown in FIG. 1 a touch switch LED illumination circuit 10 for a vehicle. The touch switch LED illumination circuit 10 includes a printed circuit board (PCB) 12. The PCB 12 includes an integrated circuit 14 and a drive circuit shown generally at 16.

The integrated circuit 14 operates to control the illumination intensity of the illumination source 18 such as a LED which is mounted remote from the PCB 12. The integrated circuit 14 receives various inputs and provides a control voltage to the drive circuit 16 for variably controlling the current provided to the illumination source 18. The integrated circuit 14 receives inputs such as an illumination on/off command input 20, a sensed battery voltage input 22, an illumination source current draw input 24, and temperature sense input 26. The integrated circuit 14 may also include a door switch input 28.

The driver circuit 16 preferably includes a FET 30, or similar device, electrically coupled to the illumination source 18 for pulse width modulating the current provided to the illumination source 18. A source 34 of the FET 30 is connected to a power source 36. An open collector pulse width modulated output 38 of the integrated circuit 14 is connected to a gate 40 of the FET 30 for variably controlling the current flow from the source 34 to a drain 42 of the FET 30. The drain 42 of the FET 30 is connected to the illumination source 18 for providing the controlled current flow to the illumination source 18. An inductor 44 may be coupled between the drain 42 and the illumination source 18 for maintaining current flow to the illumination source 18 during periods of instantaneous current increases or decreases.

The open-collector pulse width modulated output 38 of the integrated circuit 14 is electrically connected to a pull-up resistor 46 for sinking current to an active state or to provide no current flow for an inactive state. The flow of current through the FET 30 is directly controlled by the voltage applied to the gate 40 from the open-collector pulse width modulated output 38. The opening of the gate 40 (i.e., effective electrical diameter of the channel) can be varied by the application of voltage supplied by the open-collector pulse width modulated output 38 which variably controls the current flowing through the FET 30 to the illumination source 18. As a result, the intensity of the light may be variably adjusted, via pulse width modulation, for maintaining a respective level of illumination under various adverse operating conditions which could affect the output of the lighting. In addition, illumination can be controlled for creating a visual lighting affect such as theater dimming.

When utilizing a respective illumination source, such as a LED, various external conditions may affect the illumination intensity of a LED. For example, ambient temperature changes in which the LED is exposed to may affect the illumination intensity of the LED. When ambient temperature increases, the illumination output of the LED decreases. As a result, a temperature sensor 48 electrically connected to the temperature sensor input 26 of the integrated circuit 14 (which includes an analog-to-digital converter) provides sensed ambient temperature data. The temperature sensor 48 may be a standalone temperature sensor mounted separately from a respective circuit board that includes the illumination source 18 or the PCB 12. Alternatively, the temperature sensor 48 may be mounted on the PCB 12 or on a same respective circuit board as the illumination source 18. When the temperature sensor 48 senses the temperature is above a predetermined temperature threshold, the integrated circuit 14 increases the current flow to the illumination source 18, accordingly, to compensate for the temperature increase which could otherwise result in a decrease in the illumination output.

A current sense resistor 50 mounted on the PCB 12 is electrically connected to the illumination source 18. The current draw input 24 of the integrated circuit 14 (which includes an analog-to-digital converter) monitors the current flowing through the current sense resistor 50. The integrated circuit 14 variably adjusts the open-collector pulse width modulated output signal to the FET 30 in response to the current feedback for adjusting the current flowing to the illumination source 18.

The battery voltage input 22 of the integrated circuit 14 (which includes an analog-to-digital converter) senses the operating voltage of a vehicle battery (not shown) for comparison with a predetermined voltage range. In response to the operating voltage of the vehicle battery, if the battery voltage is outside of the predetermined voltage range (i.e., too low or too high), then current provided to the illumination source 18 is terminated. This prevents damage that may occur to the illumination source 18 if the supply voltage is too high or prevent further drain on the vehicle battery if the supply voltage is too low.

The various analog-to-digital converter inputs of the integrated circuit 14 described above eliminates the requirement for any additional analog comparator circuitry.

The illumination on/off command input 20 is electrically connected to touch switch antenna 52. Preferably, the touch switch antenna 52 is mounted remotely from the PCB 12 such as on a second PCB 54 which supports both the illumination source 18 and the touch switch antenna 52. The touch switch antenna 52 and the illumination source 18 may be mounted in spaced relation to one another such that the touch switch is easily identifiable and accessible to the user.

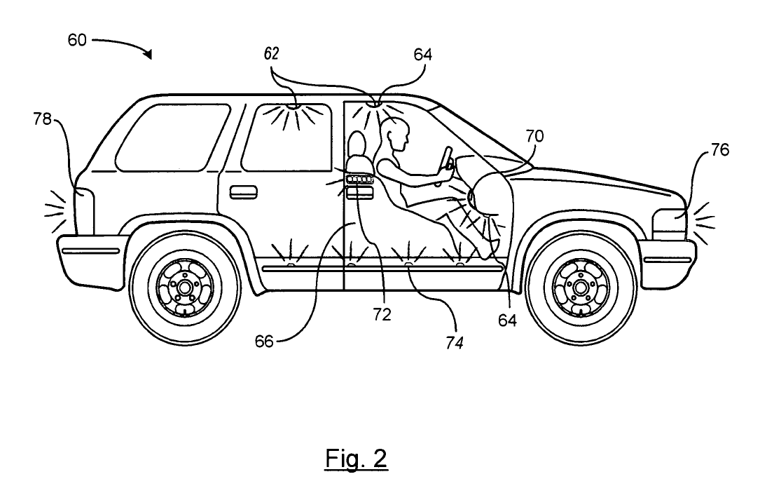

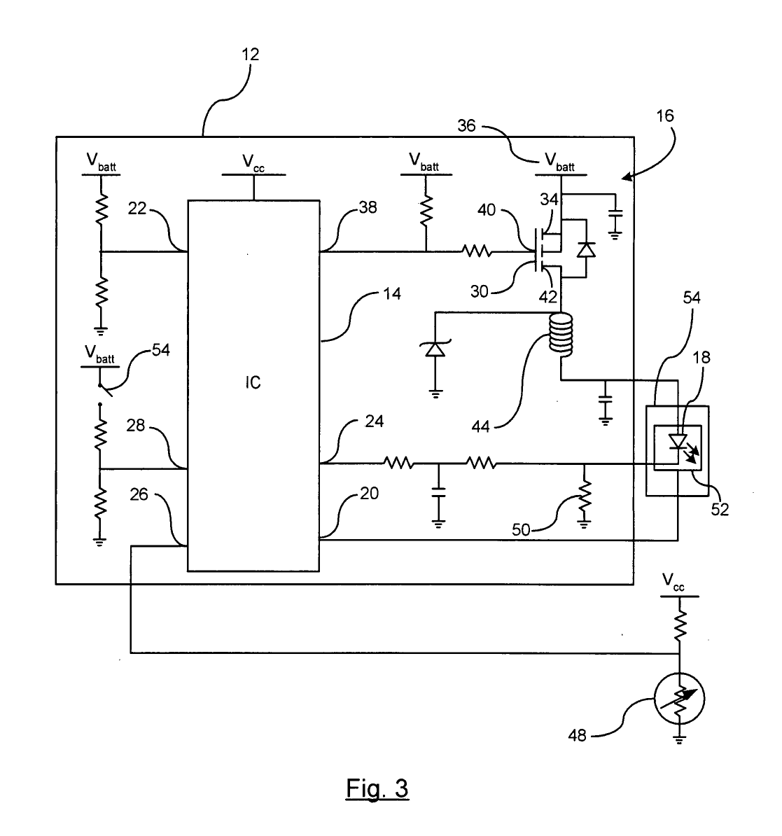

FIG. 2 shows a vehicle 60 having illumination elements 18 disposed at a plurality of vehicle interior locations and exterior locations. A first illumination source may be a vehicle interior map light 62 disposed under a protective lens cover 64. The touch switch antenna may also be positioned under the protective lens cover juxtaposed to the illumination source 18 so that the user need only touch a respective region of the protective lens cover 64 for activating the illumination source. Alternatively, the touch switch antenna 52 may form an antenna loop with the illumination source 18 being positioned within the inner region of the loop such as that shown in FIG. 3. This reduces the packaging size of a respective protective lens cover. The reduced packaging size also provides a more focused touch-activation area for a user to activate the illumination source. In alternative embodiments, the touch switch may be disposed remotely from the illumination source 18 and the PCB 12.

Referring both to FIG. 1 and 2, the door switch input 28 is electrically connected to a door switch 54 for determining when a vehicle door 66 is in an open or closed position. The illumination source 18 may be illuminated upon the sensing of the door switch 54 being in the open position for providing access lighting to a user entering the vehicle 60. In addition, upon sensing that the door switch 54 is actuated to the closed position, theater lighting may be used to slowly dim the interior lighting over a predetermined time to allow a person to get situated within the vehicle 60. The illumination source may be utilized in interior lighting that includes the dome lighting 62, interior floor lighting 68, instrument panel lighting 70, and other interior lighting. In addition to interior vehicle lighting, the illumination source 18 may be used at various regions about the exterior of the vehicle to enhance visibility. Such exterior lighting may include vehicle door keyless entry lighting 72, exterior running board lights 74, and exterior headlights 76 and backlights 78.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A vehicular touch switch activated LED illumination circuit, the circuit comprising:
a LED illumination source for providing vehicle illumination;
a touch switch antenna for sensing a user input for activating and deactivating the LED illumination source;
a printed circuit board;
an integrated circuit mounted to the printed circuit board for controlling the current provided to the LED illumination source, the integrated circuit in communication with the touch switch antenna for detecting the user input; and
a driver circuit mounted to the printed circuit board and electrically coupled to the LED illumination source for driving the LED illumination source, the integrated circuit including a battery voltage sensed input and a temperature sensed input for receiving sensed input signals to control a signal input to the driver circuit for variably controlling the current provided to the illumination source.

2. The circuit of claim 1 wherein the illumination source and the touch switch antenna are in spaced relation to one another.

3. The circuit of claim 2 wherein the illumination source and the touch switch antenna are mounted on a second printed circuit board.

4. The method of claim 3 wherein the touch switch antenna forms an antenna loop and the illumination source is mounted within an inner region of the antenna loop.

5. The circuit of claim 1 wherein driver circuit includes a current sense resistor and the integrated circuit includes an LED current monitoring input coupled to the current sense resistor for monitoring current through the current sense resistor.

6. The circuit of claim 1 wherein the driver circuit includes pulse width modulation circuitry for variably controlling the current to the LED illumination source.

7. The circuit of claim 1 wherein the integrated circuit includes touch switch circuitry for detecting a user input via the touch switch antenna.

8. The circuit of claim 1 wherein the battery voltage sensed input receives a sensed battery voltage input for determining when the battery voltage is outside of a predetermined range, the LED illumination source being de-energized when the battery voltage is outside of the predetermined range.

9. The circuit of claim 1 wherein the temperature sensed input receives ambient temperature data that is used for controlling the amount of current provided to the LED illumination source.

10. The circuit of claim 1 wherein the LED illumination source and the touch switch antenna are disposed within a translucent lens cover.

11. The circuit of claim 1 wherein the integrated circuit includes a vehicle door sensed input for determining a position of a vehicle door, the integrated circuit controlling the current supplied to the illumination source based on the position of the vehicle door.

12. The circuit of claim 8 wherein the current provided to the LED illumination source is increased in response to the vehicle door sensed input indicating the door is in an open position.

13. The circuit of claim 8 wherein the current provided to the LED illumination source is decreased in response to the vehicle door sensed input indicating the door is in a closed position.

14. The circuit of claim 1 wherein the illumination light source is associated with an interior lighted application.

15. The circuit of claim 1 wherein the illumination light source is associated with an exterior lighted application.

16. A vehicular touch switch activated LED illumination module, the module comprising:
a first printed circuit board;
a LED illumination source mounted to the first printed circuit board for providing vehicle illumination;
a touch switch antenna mounted to the first printed circuit board in spaced relation to the LED illumination source, the touch switch antenna sensing a user input for activating and deactivating the LED illumination source;
a second printed circuit board;
an integrated circuit mounted to the second printed circuit board for controlling the current provided to the LED illumination source, the integrated circuit in communication with the touch switch antenna for detecting the user input; and
a driver circuit mounted to the second printed circuit board being electrically coupled to the LED illumination source mounted on the first printed circuit board for driving the LED illumination source;
wherein the integrated circuit including a battery voltage sensed input and a temperature sensed input for receiving sensed inputs to control the signal input to the driver circuit for variably controlling the current provided to the illumination source, and wherein the first printed circuit board and the second printed circuit board are mounted in a module.

17. The module of claim 16 wherein driver circuit includes a current sense resistor, the integrated circuit including an LED current monitoring input coupled to the current sense resistor for monitoring current through the current sense resistor.

18. The module of claim 16 wherein the driver circuit includes pulse width modulation circuitry for variably controlling the current to the LED illumination source.

19. The module of claim 16 wherein the integrated circuit includes touch switch circuitry for detecting a user input via the touch switch antenna.

20. The module of claim 16 wherein the battery voltage sensed input receives a sensed battery voltage input for determining when the battery voltage is outside of a predetermined range, the LED illumination source being de-energized when the battery voltage is outside of the predetermined range.
